(19) United States
(12) Patent Application Publication
(10) Pub. No.: US 2017/0350550 A1
(43) Pub. Date: Dec. 7, 2017

(54) Apparatus for Removing a Circular Seal from the Internal Circumference of a Pipe

(71) Applicant: John Eastwood, Essex (GB)

(72) Inventor: John Eastwood, Essex (GB)

(21) Appl. No.: 15/174,817

(22) Filed: Jun. 6, 2016

(51) Int. Cl. F16L 55/18; F16L 55/26; B23P 19/04

(52) U.S. Cl. CPC F16L 55/18; B23P 19/04; F16L 55/26

(57) ABSTRACT

Apparatuses for removing a circumferential seal from the internal wall of a pipe comprise a tool for forward movement into an entry end of the pipe towards and into contact with the seal in the pipe, the tool having means for engaging the seal with the forward movement and with further forward movement of the tool release of the seal from the pipe wall and means for capturing and retaining the released seal with still further forward movement whereby on subsequent rearward movement of the tool the seal is withdrawn from the entry end of the pipe.

### CROSS-REFERENCES TO RELATED APPLICATIONS

None.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A BIOLOGICAL SEQUENCE LISTING

Not applicable.

### BACKGROUND OF INVENTION

### Field of the Invention

The present invention relates to apparatus for removing a circular seal from the internal circumference of a pipe and is in particular a specific tool to remove a circular seal from the internal circumference of a pipe. It is in the field of pipeline maintenance, more specifically in the field of pipe joint seal removal.

### Description of the Related Art

The invention is particularly directed to the removal of large diameter seals e.g. between 16″ and 48″ internal diameter from large diameter pipes of the same diameter. These pipes are made of cast iron. The seal may be of rubber or similar flexible material and may be a so-called Weko (trademark) seal. This forms a seal between two adjoining lengths of pipe. The seal may be kept in position by a one or more spring steel split rings which are positioned against the seal to keep it in place. Currently the seal and ring or rings are positioned manually by a man crawling up the pipe from an open end to place the ring in position at the joint between the two lengths of pipe.

The removal of the seals is for the purpose of pushing a plastic pipe through the old cast pipe, the seals are basically in the way of inserting the new plastic pipe and have to be removed before installation of the new plastic pipe.

They are removed in the same way that they are positioned in the first place with a man crawling up the pipe to manually lever off the seal and the associated ring or rings.

These pipes contain the residues of poisonous gases and it is undesirable for a man to crawl up the pipes and breathe in these gases.

### BRIEF DESCRIPTION OF THE INVENTION

### Objects of the Invention

It is therefore an object of the present invention to provide means whereby an internal pipe seal can be removed without a human having to enter the pipe.

### SUMMARY OF THE INVENTION

According to the present invention, there is provided apparatus for removing a circumferential seal from the internal wall of a pipe, the apparatus comprising a tool for forward movement into an open entry end of the pipe towards and into contact with the seal in the pipe, the tool having means for engaging the seal with the forward movement and with further forward movement of the tool release of the seal from the pipe wall and means for capturing and retaining the released seal with still further forward movement whereby on subsequent rearward movement of the tool the seal is withdrawn from the open entry end of the pipe.

Preferably the means for engaging and releasing the seal is a nose.

Suitably the means for capturing and retaining the released seal comprises a seal trap which, in embodiments, comprises a pivotal arm which is pivotally mounted on the tool to rest in a socket and to pivot on the tool with engagement with the seal and capture and retain the released seal with the movement of the pivotal arm and its return to the socket.

Conveniently the tool has two ends with at either end means for connection to a winch whereby in use the tool is attachable to winch cables at either end of the tool to pull the tool into the pipe from one open end of the pipe by way of one cable extending through the pipe and to withdraw the tool from another open end of the pipe by way of the other cable extending through the pipe. Optionally, the tool may be configured so that the winch cables are attached at one or more other locations on the tool. The term “winch” herein is intended to include any cable pulling device.

Preferably a cradle is provided to locate the tool at the entry end of the pipe, the tool being lowered into the cradle before attachment to the winch cable and movement through the pipe.

Suitably the tool has a body provided with wheels to permit the tool to be moved along the pipe.

Conveniently there are six wheels arranged in two pairs of three equiangularly spaced wheels around the body of the tool.

Preferably the wheels are mounted on wheel arms which are adjustable by screws to engage with the internal wall of the pipe.

Suitably the tool has a camera to permit the internal wall of the pipe to be viewed as the tool is moved along it so as to identify the seal.

### BRIEF DESCRIPTION OF THE DRAWINGS

FIG. 1 is a view of a cradle from one end for location at one end of the pipe.

FIG. 2 is a longitudinal view of the cradle.

FIG. 3 is an internal view of the pipe showing equiangularly disposed wheels of the tool engaging the internal wall of the pipe to move the tool through the pipe.

FIG. 4 is a longitudinal view of the tool inside the pipe in use.

FIG. 5 is a concrete pad on which the cradle is mounted in use.

FIG. 6 is a plan view of the cradle.

### DETAILED DESCRIPTION OF THE INVENTION

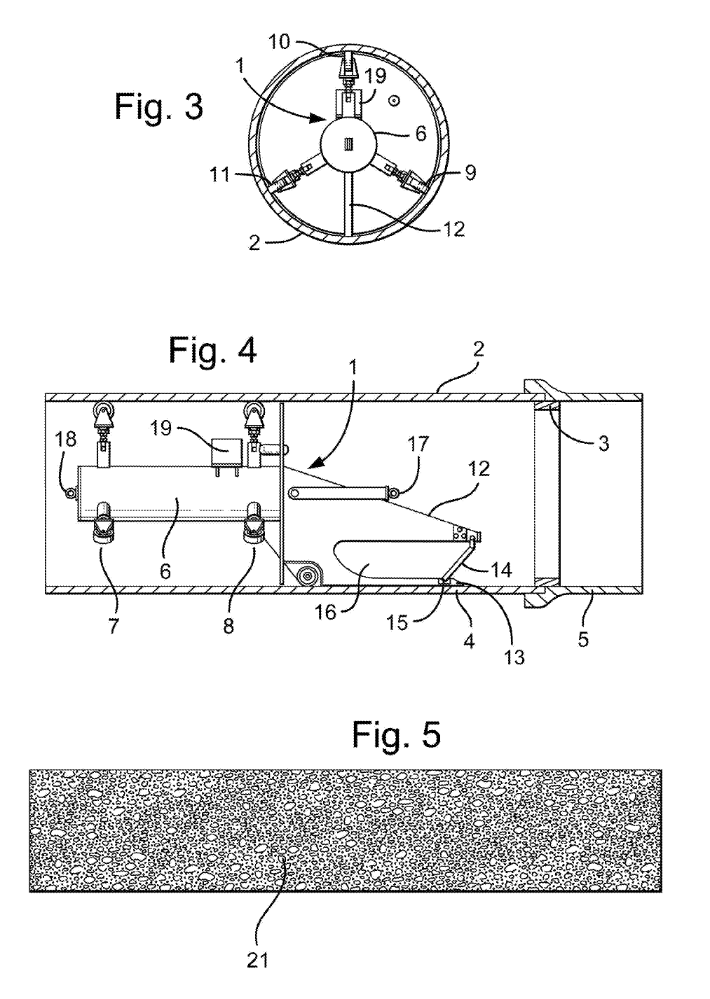

Referring now to the drawings, in which like reference characters refer to like elements among the drawings, and particularly to FIGS. 3 and 4, the apparatus comprises a tool 1 which locates within the interior of the pipe 2 which typically has an internal diameter of between 16″ and 48″ and has been cut away for access of the tool 1 to the pipe 2. The pipe 2 has a flexible rubber seal 3 joining two sections 4 and 5 of pipe together, which seal 3 is to be removed by the tool 1.

The tool 1 has a central cylindrical body 6 from which there extends two pairs 7, 8 of screw-adjustable wheels 9, 10 and 11 mounted on wheel arms. The tool 1 is adjusted to suit the internal diameter of the pipe 2 by means of adjustment of the screw adjusters on the wheel arms to adjust the position of the wheels 9, 10 and 11. Other means of adjustment of the wheel arms such as jacks or outward biasing means are included within the scope of this invention.

Located at the front end of the tool 1 is a blade-like device 12 with at the front end of the tool 1 a sharp nose 13 which with forward movement of the tool 1 to the right hand side of the pipe 1 engages the seal 3 (and any steel expansion strips if present) and lifts the seal 3 and strips away from their seat in the pipe 2.

Also formed in the blade 12 is a means for capturing and retaining the released seal 3 and any associated expansion strips. In the depicted embodiment, the means is in the form of a pivotal arm 14 which is pivoted at one end, rests in a socket 15 at the other end and forms a seal trap with an aperture 16 in the blade 12. When the tool 1 is moved forward and the seal 3 and associated strips are released by the nose 13, further movement forward of the tool 1 causes the released seal 3 and strips to engage with the pivotal arm 14 and tilt it backwards to capture the seal 3 and strips in the aperture 16. The pivotal arm 14 then tilts back to locate in the socket 15 and trap the seal 3 and strips. Other seal trap means for retaining the seal and associated strips are included within the scope of this invention, such as, by example and not limitation, an aperture 16 shaped to hold the seal and strips by gravity, or a pivotal arm 14 biased to return to socket 15 under a force other than gravity.

To move the tool 1 forwards the tool 1 is attached to a front cable (not shown) via a winch eye 17 at the forward end of the tool 1. The cable is then pulled through the pipe 2 in the right hand direction by means of a winch (not shown) to move the tool 1 and thereby engage, release and capture the seal 3.

The rear end of the tool 1 is connected to a rear cable by a winch cable eye 18 on the body 6 of the tool 1 so that after the seal 3 and any associated strip or strips have been removed and captured, the tool 1 can be pulled out of the pipe 2 in the left hand direction by means of the rear cable wound onto a winch (not shown).

A camera 19 is mounted on the body 6 of the tool 1 to identify the position of the tool 1 with respect to the seal 3 and strips so that the nose 13 can be accurately positioned to remove the seal 3 and strips, capture them and retain them for removal from the pipe 2.

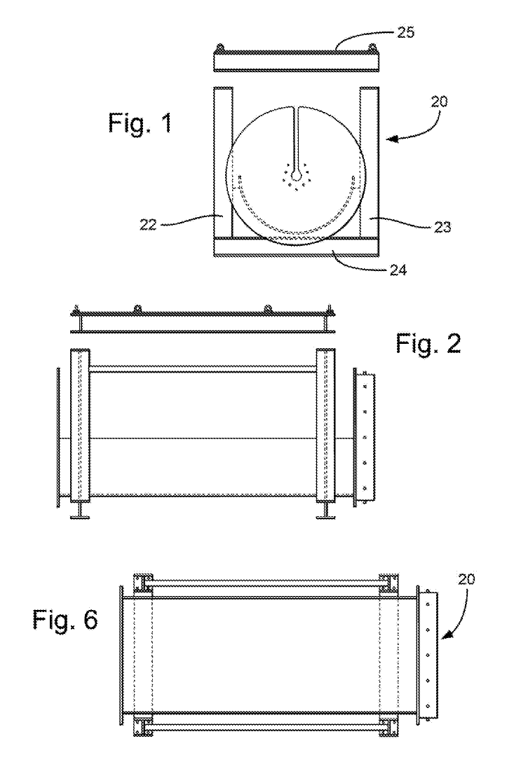

Referring to FIGS. 1, 2, 5 and 6 initially a cradle 20 from which the tool 1 is launched from the entry end of the pipe 1 is located on a concrete pad 21 (FIG. 5) which is constructed so that the top of the concrete is about 10 inches from the bottom of the pipe 2. The cradle 20 has two vertical spaced legs 22, 23, a base 24 and a removable top 25 through which the tool 1 can be lowered into position in the cradle 20. Then the top 25 can be replaced and secured to the side legs 22, 23.

After the concrete has been allowed to harden, the cradle 20 is lowered onto the pad 21. The cradle 20 has a collar (not shown) at one end. The collar is placed over the excavated pipe 2 and is centralized, four hydraulic jacks (not shown) being placed under each corner of the cross beams (not shown) of the cradle 20. The jacks are adjusted to raise and level the cradle 20 to the internal diameter of the pipe 2 at which stage the cradle and collar 20 are pushed towards the cut pipe 2. When the collar on the end of the cradle 20, being of a greater diameter than the pipe, slides over the pipe 150 mm, a series of bolts are tightened to hold the cradle 20 steady.

After the cradle 20 has been raised and centralized to the appropriate height the tool 1 is lowered into the cradle 20 and is connected to the front cable as previously described. The pairs of screw adjusters 7 and 8 on the tool 1 are then adjusted so the position of the tool 1 is centered within the pipe 2.

The winch assembly (not shown) is a Groundowinch (trademark) RW-30 for the rear of the tool 1. It is lowered onto the cradle vertical legs 22 and 23 and then bolted down (by a Hiab or crane). A drop arm (of the Groundowinch RW-30) is fixed on the winch to allow the cable to pull at the center line of the excavated pipe 2 and is adjusted to fit a back plate (not shown) on the cradle 20 and is bolted thereto. The cable is then attached to the rear of the tool 1.

At this stage the camera 19 on the tool 1 is switched on and a signal is sent to a smart phone or i-pad to display the interior of the pipe 2.

As previously described the front winch cable is attached to the eye 17 and then pulls the tool 1 from the rear end of the pipe 2 forwardly. The rear winch is put into free wheel and the tool 1 is pulled to the first seal 3 in the pipe 2. The nose 13 engages with the seal 3 and as the tool 1 is winched forward the nose 13 lifts the seal 3 away from the bottom of the pipe 2 breaking the bond between the seal 3 and the pipe 2 as the tool 1 progresses in a forward motion. The nose 13 comes out from the underside of the seal 3 and the pivotal arm 14 falls back into the socket 15 thus capturing the seal 3 and expansion strips as previously described. This will be repeated two or more times to remove two or more further seals 3 as the tool 1 moves down the pipe 2. Once three seals 3 have been captured the winches are stopped and reversed so the rear winch now pulls the tool 1 back to the cradle 20. The front winch is now in freewheel.

Once the tool 1 is back in the cradle 20 the seals 3 and strips can be removed from the aperture 16.

1. A seal removal apparatus, comprising:
a tool comprising means for forward movement into a rear open end of a pipe, the pipe having a rear open end and a front open end;
means for engaging and releasing a seal from the inside wall of the pipe with the forward movement;
means for capturing and retaining the released seal; and
means for withdrawing the tool from the rear open end of the pipe.

2. The apparatus of claim 1, in which:
said means for engaging and releasing said seal is a nose.

3. The apparatus of claim 2, in which:
said means for capturing and retaining said released seal comprises a seal trap.

4. The apparatus of claim 3, in which:
said seal trap comprises a pivotal arm which is mounted on said tool to rest in a socket and to pivot on the tool upon engagement with said released seal and capture and retain said released seal with the movement of the pivotal arm and the return of the pivotal arm to the socket.

5. The apparatus of claim 4, in which:
said means for forward movement into said rear open end of said pipe comprises a front cable;
the front cable having a first cable end attached to said tool and a second cable end attached to a front cable pulling device disposed proximate to said front open end of said pipe; and
said means for withdrawing said tool from said rear open end of said pipe comprises a rear cable;
the rear cable having a first cable end attached to said tool and a second cable end attached to a rear cable pulling device disposed proximate to said rear open end of said pipe.

6. The apparatus of claim 1, in which:
said tool comprises a body;
the body comprising a plurality of wheels; and
means for engaging at least three of the wheels with said inside wall of said pipe.

7. The apparatus of claim 6, in which:
six of said plurality of wheels are arranged in two pairs of three equiangularly-spaced wheels around said body.

8. The apparatus of claim 6, in which:
said means for engaging each of said at least three of said plurality of wheels with said inside wall comprises at least three wheel arms attached to said body at a first wheel arm end, and attached to a wheel at a second wheel arm end; and
means for adjusting each of the at least three wheel arms to contact the wheel with said inside wall.

9. The apparatus of claim 8, in which;
said means for adjusting said at least three wheel arms comprises corresponding adjusting screws.

10. The apparatus of claim 8, in which:
said tool comprises a camera; and
means for displaying the camera image outside said pipe.

11. The apparatus of claim 8, comprising:
a cradle to locate said tool at said rear open end of said pipe.

12. The apparatus of claim 5, in which:
said tool comprises a body;
the body comprising a plurality of wheels; and
means for engaging at least three of the plurality of wheels with said inside wall of said pipe.

13. The apparatus of claim 12, in which:
six of said plurality of wheels are arranged in two pairs of three equiangularly-spaced wheels around said body.

14. The apparatus of claim 12, in which:
said means for engaging each of said at least three of said plurality of wheels with said inside wall comprises at least three wheel arms attached to said body at a first wheel arm end, and attached to a wheel at a second wheel arm end; and
means for adjusting the at least three wheel arms to contact the wheel with said inside wall.

15. The apparatus of claim 14, in which;
said means for adjusting said at least three wheel arms comprises corresponding adjusting screws.

16. The apparatus of claim 14, in which:
said tool comprises a camera; and
means for displaying the camera image outside said pipe.

17. The apparatus of claim 14, comprising:
a cradle to locate said tool at said rear open end of said pipe.

18. A method of using the tool of claim 11, comprising the steps of:
(a) positioning said tool proximate to said rear open end of said pipe;
(b) attaching said first end of said front cable to said tool;
(c) actuating said front cable pulling device to move said tool into said rear open end;
(d) adjusting said at least three wheel arms to contact said wheel with said inside wall;
(e) attaching said first end of said rear cable to said tool;
(f) actuating said camera;
(g) actuating said front cable pulling device to move said tool into proximity with said seal;
(h) actuating said front cable pulling device until said nose engages and releases said seal from said pipe wall;
(i) actuating said front cable pulling device until said released seal is retained in said seal trap;
(j) optionally actuating said front cable pulling device until said nose engages and releases at least one additional said seal from said pipe wall;
(k) optionally actuating said front cable pulling device until said released additional seal is retained in said seal trap; and
(l) actuating said rear cable pulling device to move said tool toward said rear open end.

19. The method of claim 18, comprising the additional steps of:
(1) prior to said step (a), placing said tool in said cradle; and
(2) positioning said cradle to locate said tool proximate said rear open end of said pipe.

20. A method of using the tool of claim 17, comprising the steps of:
(a) positioning said tool proximate to said rear open end of said pipe;
(b) attaching said first end of said front cable to said tool;
(c) actuating said front cable pulling device to move said tool into said rear open end;
(d) adjusting said at least three wheel arms to contact said wheel with said inside wall;
(e) attaching said first end of said rear cable to said tool;
(f) actuating said camera;
(g) actuating said front cable pulling device to move said tool into proximity with said seal;
(h) actuating said front cable pulling device until said nose engages and releases said seal from said pipe wall;
(i) actuating said front cable pulling device until said released seal is retained in said seal trap;
(j) optionally actuating said front cable pulling device until said nose engages and releases at least one additional said seal from said pipe wall;
(k) optionally actuating said front cable pulling device until said released additional seal is retained in said seal trap; and
(l) actuating said rear cable pulling device to move said tool toward said rear open end.

21. The method of claim 20, comprising the additional steps of:
(1) prior to said step (a), placing said tool in said cradle; and
(2) positioning said cradle to locate said tool proximate said rear open end of said pipe.
